(19) United States
(12) Patent Application Publication
(10) Pub. No.: US 2006/0188653 A1
(43) Pub. Date: Aug. 24, 2006

(54) Blade coating method and apparatus

(75) Inventors: Shinsuke Takahashi, Kanagawa (JP); Takayoshi Ose, Kanagawa (JP); Satoshi Matsubaguchi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/342,563

(22) Filed: Jan. 31, 2006

(30) Foreign Application Priority Data
Feb. 21, 2005 (JP) P.2005-043948

(51) Int. Cl. B05D 1/32; B05C 3/02

(52) U.S. Cl. 427/282; 118/413; 118/409

(57) ABSTRACT

A blade coating method using a plurality of blades for applying coating liquid on surfaces of disk-like flat substrates to thereby form coating layers on to-be-coated surfaces of the flat substrates respectively, the method comprising: the attaching step as defined herein; and the moving step as defined herein; wherein after a first one of the blades applies the coating liquid on a surface of a disk-like flat substrate in a direction, the first blade retracts and a second one of the blades applies the coating liquid on a surface of a next disk-like flat substrate in a direction reverse to the direction applied by the first blade.

### FIELD OF THE INVENTION

The present invention relates to a blade coating method and apparatus for applying coating liquid on a flat substrate.

### BACKGROUND OF THE INVENTION

A coating method such as roll coating, gravure coating and extrusion coating is heretofore known as a coating method for applying coating liquid on a support.

A blade coating method as described in JP-A-5-220966 is also known as a coating method for applying coating liquid on a flat substrate.

### SUMMARY OF THE INVENTION

FIG. 22 is a perspective view showing a blade coating apparatus as a subject of the invention. FIG. 23 is an enlarged sectional view of a blade.

The blade coating apparatus 100 is used for applying coating liquid on a flat substrate to form a coating layer thereon. For example, a disk-like recording medium (hereinafter referred to as “disk”) D is used as the flat substrate which is a subject of coating.

The disk D is supported by a support member 40 (FIGS. 24A to 24C) while a to-be-coated surface of the disk D to be coated with the coating liquid is turned up. The support member 40 is formed so that the support member 40 can be driven to move up and down. Accordingly, the vertical position of the flat substrate can be adjusted to a predetermined position at any time, for example, at the time of placing the disk D on the support member, at the time of removing the disk D from the support member after coating, or at the time of performing coating.

A plate-like mask 30 is provided above the disk D. The mask 30 has an aperture 30a for exposing a to-be-coated surface D1 as an upper surface of the disk D on which a coating layer will be formed. The aperture 30a is shaped like a circle with a diameter of about 120 mm. Incidentally, the shape of the aperture 30a can be formed in accordance with the shape of the coating layer which will be formed on the disk D. When the shape of the aperture of the mask 30 is changed suitably, the shape of the coating layer can be set desirably. At the time of coating the disk D, the supported disk D is attached onto a lower surface of the mask 30 and retained in the condition that an outer circumferential edge of the disk D overlaps with a circumferential edge of the aperture of the mask 30 in view from above.

A blade 20 is provided above the mask 30. The blade 20 is a long member made of a metal material such as a stainless steel material. Particularly, it is preferable that the chromium content of the blade 20 is selected to be not lower than the chromium content of SUS316. In this manner, wear resistance, corrosion resistance, heat resistance and releasability of the blade 20 can be improved more greatly. As shown in FIG. 23, the blade 20 is formed so that a section of the blade 20 perpendicular to the lengthwise direction of the blade 20 is substantially shaped like a trapezoid.

The blade coating apparatus 100 is provided with a coating liquid supply unit 60 for supplying coating liquid to an upper surface of the mask 30. The coating liquid supply unit 60 supplies a predetermined amount of coating liquid P onto the upper surface of the mask 30 and between the aperture 30a and the blade 20 before coating or at every coating.

As shown in FIG. 23, a gap G is formed between the blade 20 and the mask 30. As a flow of the coating liquid P is guided by a front surface 20a′ of the blade 20, the coating liquid P is pressed and forced into the gap G. A pressure surface 20b′ is formed as a lower end surface of the blade 20 facing the to-be-coated surface D1. When the coating liquid P passes through the pressure surface 20b by a distance L, the coating liquid P is loaded into the aperture 30a of the mask 30. As shown in FIG. 22, at the time of coating, the blade 20 moves along the mask surface above the mask 30 while the front surface 20a′ presses the coating liquid P against the aperture 30a side. In this manner, the coating liquid P is applied on the to-be-coated surface D1 evenly.

It is preferable that a coating liquid with a viscosity of 150 cP to 800 cP is used as the coating liquid P. It is especially preferable that a coating liquid with a viscosity of 200 cP to 700 cP is used as the coating liquid P.

It is preferable that an angle α between the pressure surface 20b′ and the front surface 20a′ of the blade 20 is set to be in a range of 110°≦α≦150°. In addition, it is preferable that an angle β between the pressure surface 20b′ and a rear surface 20c′ of the blade 20 is set to be in a range of 60°≦β<100°. Moreover, it is preferable that the gap G between the pressure surface 20b′ of the blade 20 and the mask 30 is set to be in a range of 20 μm≦G≦150 μm.

Next, a method using the blade boating apparatus 100 for applying the coating liquid will be described.

FIGS. 24A to 24C are explanatory views showing the first half of a procedure in the coating method according to the invention. FIGS. 25D to 25G are explanatory views showing the second half of the procedure in the coating method according to the invention.

In this blade coating method, a coating liquid P is applied on a to-be-coated surface D1 of a disk D exposed from the aperture 30a of the mask 30 under the condition that at least one of straightness and center-line average surface roughness satisfies the aforementioned ranges to make the blade 20 satisfy the aforementioned ranges.

First, the disk D is disposed on the support member 40 shaped like a table. As shown in FIG. 24A, the support member 40 is moved up to make the disk D abut on the aperture 30a of the mask 30.

Then, as shown in FIG. 24B, a mask cap 50 is moved down toward a central hole D2 of the disk D. Finally, as shown in FIG. 24C, the mask cap 50 is inserted into the central hole D2 of the disk D. The coating liquid P is supplied onto an end of the mask 30 by the coating liquid supply unit 60 shown in FIG. 22. The blade 20 is moved in a direction represented by an arrow Y.

FIG. 25D shows a state in which the blade 20 is to reach the aperture 30a after the movement of the blade 20 starts. FIG. 25E shows a state in which the blade 20 has already passed through the aperture 30a.

By the movement of the blade 20 from right to left in FIGS. 25D and 25E, a coating liquid layer with a predetermined thickness t1 is formed on the to-be-coated surface D1 of the disk D because the blade 20 passes through the to-be-coated surface D1 of the disk D while carrying the coating liquid P.

Then, as shown in FIG. 25F, the mask cap 50 is pulled out of the disk D. In this manner, a circular step portion D2 which is not coated with the coating liquid P is formed in a central portion of the disk D. Then, as shown in FIG. 25G, the support member 40 is moved down so that the disk D is pulled down apart from the aperture 30a of the mask 30. Thus, the coating liquid P applied on the to-be-coated surface D1 is separated from the coating liquid P remaining on the mask 30. As a result, an uncoated portion D3 which is not coated with the coating liquid P is formed in an outer circumferential edge of the disk D covered with the mask 30.

The disk D completely coated with the coating liquid P as described above is removed from the support member 40 and transferred to a coating liquid drying process which is a next process not shown.

FIGS. 26A and 26B are views showing a state in which the disk D is separated from the mask. FIG. 26A is a perspective view showing the time of ascending of the support member. FIG. 26B is a perspective view showing the time of descending of the support member. In the blade coating apparatus 100, while the disk D is supported by the support member 40 which can be driven to move up and down, a drive member 41 drives the support member 40 to move up to an upper position so that a portion of the disk D except the to-be-coated portion is attached to a mask 30 having an aperture 30a. In this condition, a long blade 20 is moved in the direction of the arrow Y above the upper surface of the mask 30 to thereby scrape and extend the coating liquid P supplied onto the mask 30. In this manner, the coating liquid P is accumulated on the to-be-coated portion exposed from the aperture 30a, so that a coating layer of the coating liquid P is formed on the disk D.

After the coating liquid is applied on the disk D, the mask cap 50 (FIG. 25F) is removed. As shown in FIG. 26B, the support member 40 is then moved down so that the flat substrate D having the coating layer P formed thereon is separated from the mask 30.

For example, this coating method can be applied to a means of forming a printing surface on a disk-like substrate by blade coating (or doctor blade coating) in a process for producing a magnetic recording medium including the substrate. FIG. 27 is a plan view of a disk coated with a coating liquid by such a coating method using the blade 20 and the mask 30. In view of the disk, almost 100% of the whole surface of the disk D is coated with a coating liquid, that is, slight portions such as a central portion D2 of the disk D and an outer circumferential portion D3 of the disk D are not coated with a coating liquid.

When a coating liquid is applied by a blade 20 using a high-aperture-ratio mask 30 in the aforementioned manner, a large quantity of the coating liquid is consumed at one stroke of the blade 20, differently from screen printing. When the quantity of the coating liquid to be consumed at one stroke of the blade 20 is assumed to be Q, the background-art apparatus supplies a quantity of the coating liquid equal to a value of from about 1.0Q to 1.2Q every time so that the coating liquid can be applied and printed on a disk D without waste of a large amount of the coating liquid.

The present inventor has however found that scratches and stripes often occur in portions of the disk D when such a quantity (1.0Q to 1.2Q) of the coating liquid is used. As a result of examination of the reason, it has been found that the quantity of the coating liquid to be consumed varies at least twice in accordance with portions of the blade in the lengthwise direction of the blade, that is, a large quantity of the coating liquid is used in a direction (diametral direction) passing through the vicinity of the center of the disk D while a very small quantity of the coating liquid is used in the same direction passing through the circumference of the disk D. Therefore, if a quantity of coating liquid corresponding to the quantity of the coating liquid to be consumed can be initially supplied onto each portion accurately, the required quantity of the coating liquid is Q theoretically (in a steady state in which the coating liquid is not attached to the blade or mask any more). It is however extremely difficult to achieve this manner in practice.

As a result of an experiment conducted then, it has been however found that when a quantity of coating liquid not smaller than 2Q is supplied initially, it is possible to obtain a coating layer without occurrence of thickness irregularity in the whole surface and with a very good uniform thickness. On the contrary, when a too large quantity of coating liquid, for example, 10Q is supplied initially, thickness irregularity occurs unfavorably. It has been therefore finally found that the preferred quantity of coating liquid supplied initially is in a range of from 2Q to 5Q.

In the solution of supplying a quantity of coating liquid not smaller than 2Q initially, there is however a problem which did not occur in the background-art apparatus of the type in which the coating liquid was spent fully every time. That is, even after one stroke of the blade 20, the coating liquid cannot be spent fully so that the quantity of the coating liquid remaining on the mask 30 becomes unignorably large. How to handle the residual part of the coating liquid comes into question.

As a first countermeasure, it is conceived that the residual part of the coating liquid is discarded every time and a quantity 2Q to 5Q of coating liquid is supplied newly for the next stroke. This is against resource saving because of a lot of waste.

As a second countermeasure, it is conceived that the residual part of the coating liquid is collected in a collection tank, re-supplied to the nozzle 60 and reused. This countermeasure is not preferable because a lot of expensive parts such as a collection tank, a re-supply pipe, etc. are required newly and because the residual part of the coating liquid is dried into solid matter in the middle of collection so that the solid matter may cause pipe choking or may be applied on the disk D.

In order to eliminate these disadvantages, an object of the invention is to provide a blade coating method and apparatus in which waste can be avoided, resources can be saved, new expensive parts such as a collection tank, a re-supply pipe, etc. can be dispensed with, and coating liquid is not dried into solid matter.

(1) In order to solve the problem, the invention provides a blade coating method using a plurality of blades for applying coating liquid on surfaces of disk-like flat substrates to thereby form coating layers on to-be-coated surfaces of the flat substrates respectively, including the steps of: attaching a mask onto a flat substrate, the mask having an aperture large enough to apply the coating liquid on the whole surface of the flat substrate except a circumferential edge portion of the flat substrate; and moving each blade from an upstream side to a downstream side relative to the mask with a predetermined gap formed between the blade and the flat substrate, thereby extruding the coating liquid onto the mask through the gap formed on the downstream side of the blade while moving the coating liquid supplied on the upstream side of the blade by the blade to thereby form the coating layer on the surface of the flat substrate; wherein after a first one of the blades applies the coating liquid on a surface of a disk-like flat substrate in a direction, the first blade retracts and a second one of the blades applies the coating liquid on a surface of a next disk-like flat substrate in a direction reverse to the direction applied by the first blade.

(2) The invention provides a blade coating method using a blade for applying coating liquid on surfaces of disk-like flat substrates to form coating layers on to-be-coated surfaces of the flat substrates respectively, including the steps of: attaching a mask onto a flat substrate, the mask having an aperture large enough to apply the coating liquid on the whole surface of the flat substrate except a circumferential edge portion of the flat substrate; and moving the blade from an upstream side to a downstream side relative to the mask with a predetermined gap formed between the blade and the flat substrate, thereby extruding the coating liquid onto the mask through the gap formed on the downstream side of the blade while moving the coating liquid supplied on the upstream side of the blade by the blade to thereby form the coating layer on the surface of the flat substrate; wherein after the blade applies the coating liquid on a surface of a disk-like flat substrate in a direction, the blade moves to an opposite side with respect to a residual part of the coating liquid and subsequently applies the coating liquid on a surface of a next disk-like flat substrate in a reverse direction to the direction.

(3) The invention provides an optical disk having at least one layer of a printable surface formed by a blade coating method according to the paragraph (1) or (2).

(4) The invention provides a blade coating apparatus including: a subject attachment for attaching a disk-like flat substrate as a subject on which coating liquid will be applied; a first blade for moving from an upstream side to a downstream side above the subject attachment and relative to the subject attachment with a predetermined gap formed between the first blade and the subject attachment; a second blade for moving from the downstream side to the upstream side above the subject attachment and relative to the subject attachment with a predetermined gap formed between the second blade and the subject attachment; and a nozzle for supplying the coating liquid to at least one side of the first and second blades; wherein after the first blade applies the coating liquid on a surface of a disk-like flat substrate in a direction, the first blade retracts and the second blade applies the coating liquid to a surface of a next disk-like flat substrate in a direction reverse to the direction applied by the first blade.

(5) The invention provides a blade coating apparatus including: a subject attachment for attaching a disk-like flat substrate as a subject on which coating liquid will be applied; a first blade for moving from an upstream side to a downstream side above the subject attachment and relative to the subject attachment with a predetermined gap formed between the first blade and the subject attachment; a second blade for moving from the downstream side to the upstream side above the subject attachment and relative to the subject attachment with a predetermined gap formed between the second blade and the subject attachment; a first nozzle for supplying the coating liquid to the first blade side; and a second nozzle for supplying a coating liquid to the second blade side; wherein: the first blade applies the coating liquid from the upstream side to the downstream side after the first nozzle supplies the coating liquid; and the second blade applies the coating liquid from the downstream side to the upstream side after the second nozzle supplies the coating liquid.

(6) The invention provides a blade coating apparatus according to the paragraph (5), wherein: the first nozzle supplies the coating liquid when the first blade is on the downstream side of the subject attachment; and the second nozzle supplies the coating liquid when the second blade is on the upstream side of the subject attachment.

(7) The invention provides a blade coating apparatus including: a subject attachment for attaching a disk-like flat substrate as a subject on which coating liquid will be applied; a blade for moving from an upstream side to a downstream side above the subject attachment and relative to the subject attachment with a predetermined gap formed between the blade and the subject attachment; and a nozzle for supplying the coating liquid onto a front end of the blade in a direction of movement of the blade; wherein after the blade applies the coating liquid on a surface of a disk-like flat substrate in a direction, the blade moves to an opposite end with respect to a residual part of the coating liquid and subsequently applies the coating liquid on a surface of a next disk-like flat substrate in a reverse direction to the direction.

(8) The invention provides a blade coating apparatus according to the paragraph (7), wherein after the blade applies the coating liquid on a surface of a disk-like flat substrate in a direction, the blade is moved above the residual part of the coating liquid, rotated around the residual part of the coating liquid by 180° in a horizontal plane, moved down to the opposite end with respect to the residual part of the coating liquid, and subsequently applies the coating liquid on a surface of a next disk-like flat substrate in a reverse direction to the direction.

(9) The invention provides a blade coating apparatus according to any one of the paragraphs (4) to (8), wherein each nozzle supplements coating liquid once each stroke or once each predetermined number of strokes so that the blade can always move a quantity of the coating liquid equal to two times to five times as much as the quantity of the coating liquid to be applied on the flat substrate with one stroke of the blade.

(10) The invention provides a blade coating apparatus according to any one of the paragraphs (4) to (9), further including coating liquid leakage preventing dams which are laid at a predetermined distance from opposite ends of the blade respectively and in parallel to the direction of movement of the blade.

In the blade coating method according to the invention, a coating layer with a very good uniform thickness can be obtained because a sufficient quantity of coating liquid is supplied initially so that any portion of a disk D is supplied with a sufficient quantity of coating liquid. In addition, the coating liquid once supplied can be spent fully without drying because a fresh coating liquid is added to the residual part of the coating liquid so that the coating liquid is kept in a movable state.

### BRIEF DESCRIPTION OF THE DRAWINGS

FIG. 1 is a perspective view showing a blade coating apparatus according to Embodiment 1.

FIG. 2 is a perspective view showing an initial state of the blade coating apparatus according to Embodiment 1.

FIG. 3 is a perspective view of a state in which a coating liquid is discharged from a nozzle and supplied onto a mask.

FIG. 4 is a perspective view of a state in which a blade has applied the coating liquid on a disk halfway.

FIG. 5 is a perspective view of a state in which the blade has applied the coating liquid on the whole surface of the disk completely.

FIG. 6 is a perspective view of a state in which the blade has retracted to a retraction position located above.

FIG. 7 is a perspective view of a state in which a second blade starts to move while carrying a residual coating liquid and a newly discharged coating liquid.

FIG. 8 is a perspective view of a state in which the second blade has applied the coating liquid on a disk halfway.

FIG. 9 is a perspective view of a state in which the second blade has applied the coating liquid on the whole surface of the disk completely.

FIG. 10 is a perspective view of a state in which the second blade having reached a final goal is retracted to an upper position.

FIG. 11 is a perspective view of a state in which the second blade is returned while kept in a retraction state.

FIG. 12 is a perspective view of a state in which the first and second blades are returned to a final goal.

FIG. 13 is a perspective view of a state in which the first blade has reached the final goal after a coating liquid P is applied on the whole surface of a disk.

FIG. 14 is a perspective view of a state in which the blade according to Embodiment 1 has applied the coating liquid on the whole surface of the disk completely.

FIG. 15 is a perspective view for explaining a blade coating apparatus according to Embodiment 2, in which one blade has reached a final goal after a coating liquid is applied on a disk.

FIG. 16 is a perspective view of a state in which the blade has been moved up.

FIG. 17 is a perspective view of a state in which the moved-up blade is rotated by 180° in a horizontal plane.

FIG. 18 is a perspective view of a state in which the blade having been rotated by 180° is landed on a mask.

FIG. 19 is a perspective view of a state in which the blade according to Embodiment 2 starts to move in a reverse direction.

FIGS. 20A to 20C are views for explaining a modification of the blade coating apparatus according to Embodiment 2.

FIG. 21 is a perspective view showing a blade coating apparatus according to Embodiment 3 of the invention.

FIG. 22 is a perspective view showing a blade coating apparatus according to the background art.

FIG. 23 is an enlarged sectional view of a blade.

FIGS. 24A to 24C are explanatory views showing a procedure in a coating method according to the invention.

FIGS. 25D to 25G are explanatory views showing the procedure in the coating method according to the invention, following FIG. 24C.

FIGS. 26A and 26B are views showing a state in which a member (disk) as a subject of coating is separated from a mask.

FIG. 27 is a plan view of the coated member (disk) as a subject of coating.

### DESCRIPTION OF REFERENCE NUMERALS

10 blade coating apparatus according to Embodiment 1 of the invention
10′ blade coating apparatus according to Embodiment 2 of the invention
10″ blade coating apparatus according to Embodiment 3 of the invention
20, 20a, 20b, 20c, 60d blade
30 mask
30a aperture
40 support member
50 mask cap
60a, 60b, 60c coating liquid supply unit
D a disk-like recording medium (disk) as a subject of coating
D1 to-be-coated surface
D2 central hole of the disk
D3 uncoated portion
P, P1, P2, P3 coating liquid
Y direction of movement of blade
Z direction of vertical movement of the support member

### DETAILED DESCRIPTION OF THE INVENTION

Embodiments of the invention as to a blade coating method applied to a disk printing surface coating apparatus will be described below in detail with reference to the drawings.

### Embodiment 1

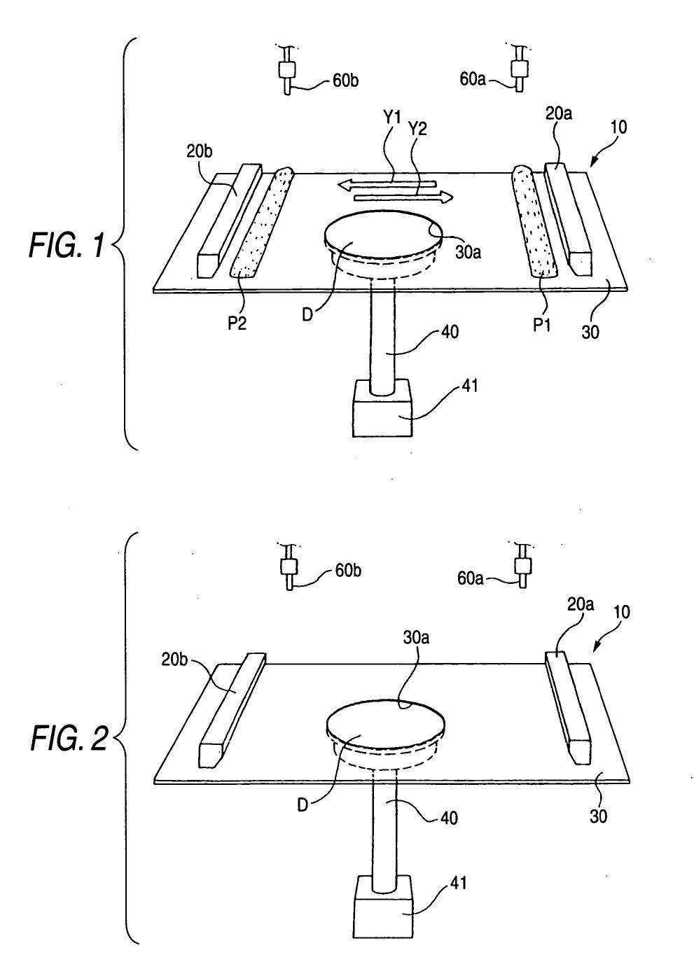

FIG. 1 is a perspective view showing a state in which all constituent parts, etc. used in Embodiment 1 are exhibited. As is obvious from comparison between a blade coating apparatus 10 in Embodiment 1 and a background-art apparatus 100 shown in FIG. 22, there is a large difference in that the blade coating apparatus 10 in Embodiment 1 has two blades 20a and 20b and two coating liquid supply units (hereinafter referred to as “nozzles”) 60a and 60b above a mask 30 whereas the background-art apparatus 100 shown in FIG. 22 has one blade 20 and one coating liquid supply unit 60 above a mask 30.

Incidentally, in FIG. 1, P1 and P2 designate coating liquids discharged from the nozzles 60a and 60b respectively and supplied onto the mask 30. Y1 and Y2 designate directions of movement of the blades 20a and 20b respectively.

On the other hand, respective names and functions of constituent parts the same as those in the background-art apparatus shown in FIG. 22 are referred to by the same numerals correspondingly, so that redundant description thereof will be omitted.

Although a mask cap 50 is also required in this embodiment, illustration and operation of the mask cap 50 will be omitted for the sake of simplification of description of the invention because the mask cap 50 is operated in the same manner as in the background-art apparatus.

Operation of the blade coating apparatus 10 according to Embodiment 1 shown in FIG. 1 will be described below with reference to FIGS. 2 to 14.

As for FIG. 2:

FIG. 2 shows an initial state of the blade coating apparatus 10 according to Embodiment 1. Therefore, the blades 20a and 20b and the nozzles 60a and 60b are returned to their origins and in a standby state. A new disk D having its surface to be coated is placed on a support member 40 and fixed by vacuum suction. In this condition, the disk D is moved up by a motor 41 and brought into close contact with a rear surface of the mask 30 so that a to-be-coated portion of the disk D faces an opening 30a of the mask 30.

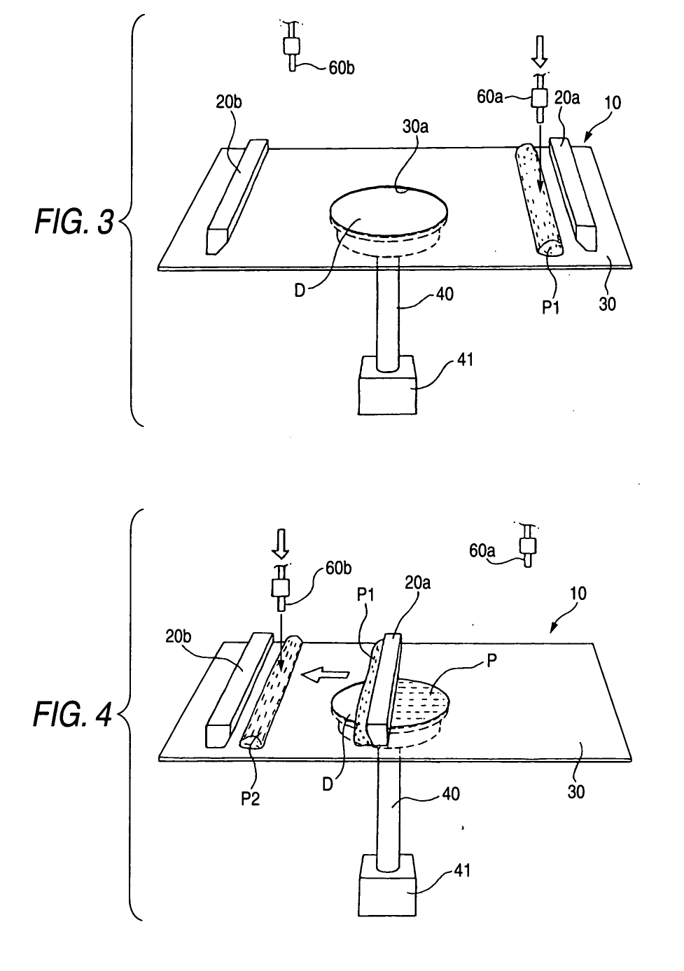

As for FIG. 3:

FIG. 3 shows a state in which a coating liquid P1 is just discharged from the nozzle 60a which is moved down from a retraction position where the nozzle 60a does not interfere with a drive device (not shown) located above the blade 20a to a discharge/supply position where the nozzle 60a discharges the coating liquid P1 and supplies the coating liquid P1 onto the mask 30.

Then, the nozzle 60a retracts to the original retraction position. The blade 20a starts to move in the Y1 direction (FIG. 1).

Incidentally, description has been made on the case where the coating liquid P1 is discharged uniformly from the nozzle 60a moved in a lengthwise direction of the blade 20a. Alternatively, a plurality of fixed injectors may be disposed at intervals of a predetermined pitch in the lengthwise direction of the blade 20a so that spots of the coating liquid P1 are discharged from the injectors respectively.

As for FIG. 4:

FIG. 4 shows a state in which the coating liquid P has been already applied on a half part of the new disk D by the blade 20a moved approximately to a half position of the opening 30a (FIG. 3).

On this occasion, a coating liquid P2 is discharged from the nozzle 60b which is moved down from a retraction position where the nozzle 60b does not interfere with a drive device (not shown) located above the blade 20b to a discharge/supply position where the nozzle 60b discharges the coating liquid P2 and supplies the coating liquid P2 onto the mask 30.

Alternatively, the coating liquid P2 may be discharged and supplied from the nozzle 60b at the same timing as shown in FIG. 3.

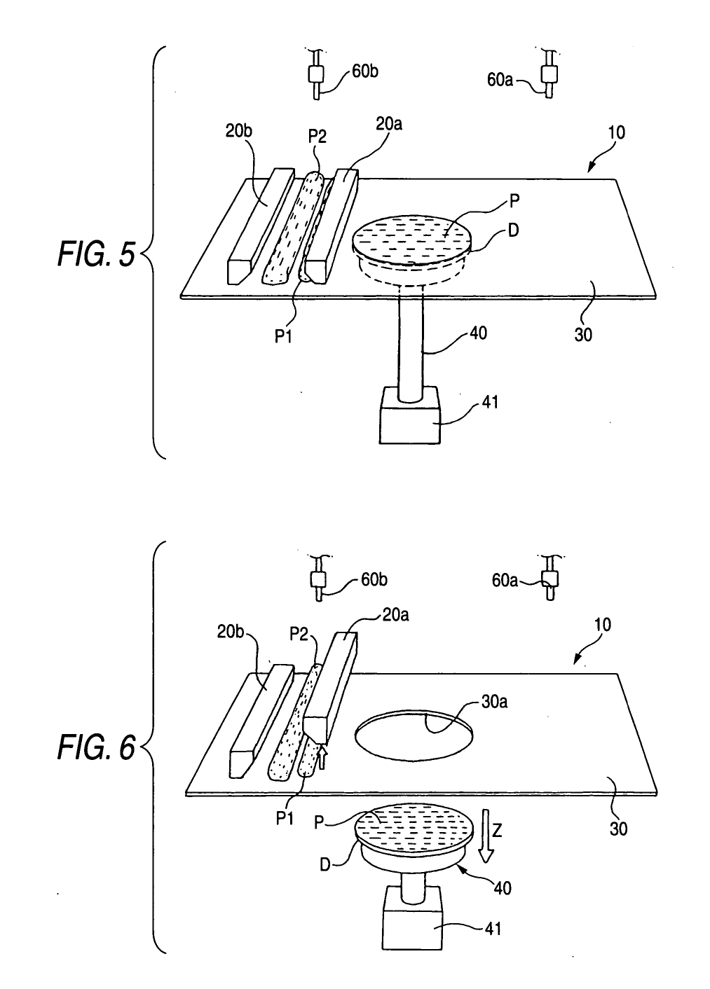

As for FIG. 5:

FIG. 5 shows a state in which the blade 20a has reached a final goal after the coating liquid P is applied on the whole surface of the disk D. On this occasion, a sufficient amount of the coating liquid P1 remains behind the front end of the blade 20a.

In this background-art apparatus, there is a possibility that scratches will be generated partially on the disk surface because a sufficiently small amount of coating liquid is supplied so that there is no remaining coating liquid P1. On the other hand, in the invention, there is no possibility that scratches will be generated partially on the disk surface because a sufficiently large amount 2Q to 5Q of coating liquid is supplied so that there is a remaining coating liquid P1.

Furthermore, the invention is characterized in that the residual coating liquid P1 is neither discarded nor collected in a collection tank but reused immediately with a new coating liquid P2.

As for FIG. 6:

In FIG. 6, the blade 20a having reached the final goal completes its role and retracts upward. At the same time, the disk D coated with the coating liquid P is moved down in a Z direction by the motor 41 while placed on the support member 40.

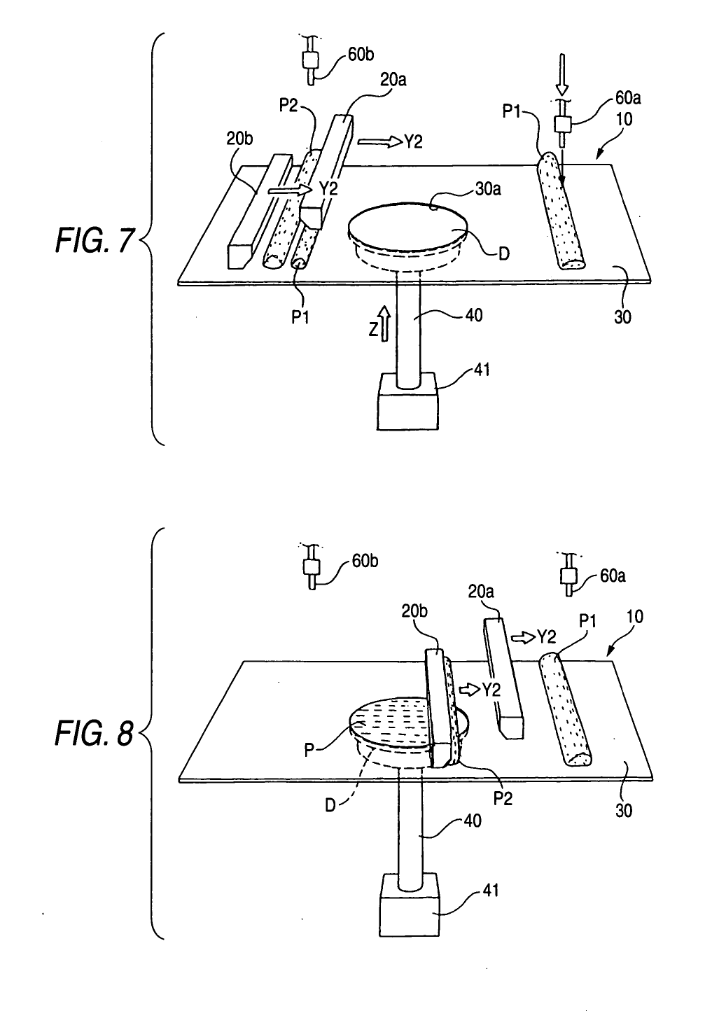

As for FIG. 7:

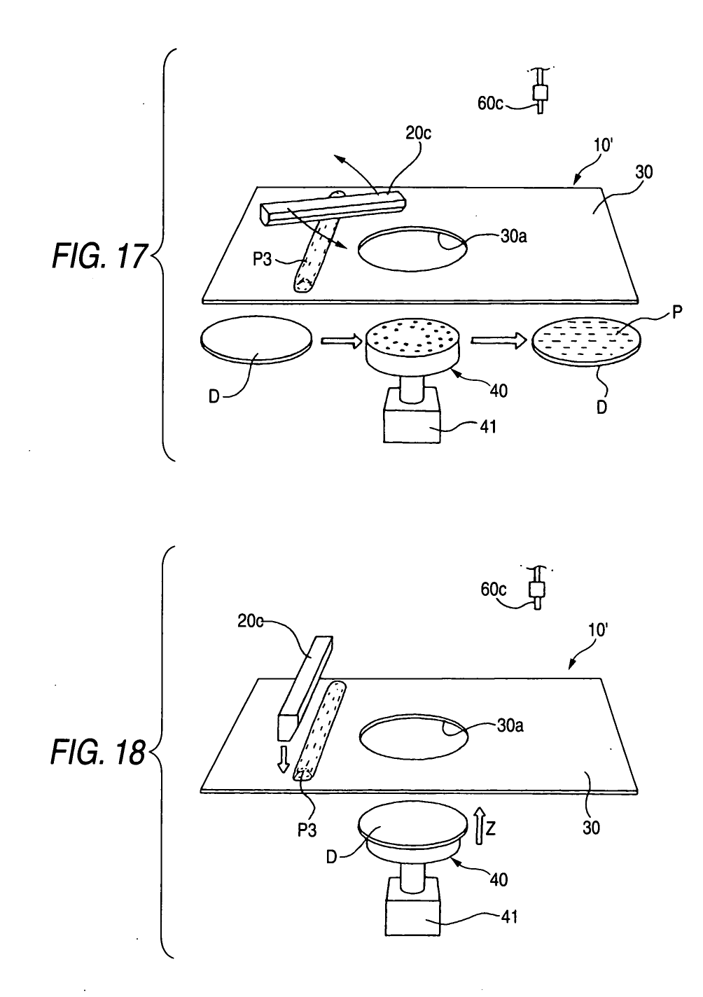

In FIG. 7, the disk D coated completely is removed from the support member 40 (as will be described in FIG. 17) after the disk D is moved down as shown in FIG. 6. A new disk D to be coated next is then placed on the support member 40 and fixed by vacuum suction. In this condition, the new disk D is moved up in the Z direction by the motor 41 and brought into close contact with the rear surface of the mask 30 again so that a to-be-coated portion of the new disk D faces the opening 30a of the mask 30.

The blade 20a starts to move in the Y2 direction while kept in a retraction state (rise state). The blade 20b also starts to move in order to move the residual coating liquid P1 and a newly discharged coating liquid P2 in the Y2 direction.

On this occasion, the nozzle 60a is moved down from above the blade 20a to the discharge/supply position so that the coating liquid P1 is discharged from the nozzle 60a and supplied onto the mask 30.

As for FIG. 8:

FIG. 8 shows a state in which the blade 20b has moved the coating liquids P1 and P2 approximately to the center of the opening 30a (FIG. 3) in the Y2 direction so that the coating liquids P1 and P2 have been applied on a half part of the new disk D. In the meanwhile, the blade 20a is still moving in the Y2 direction while kept in the retraction state (rise state).

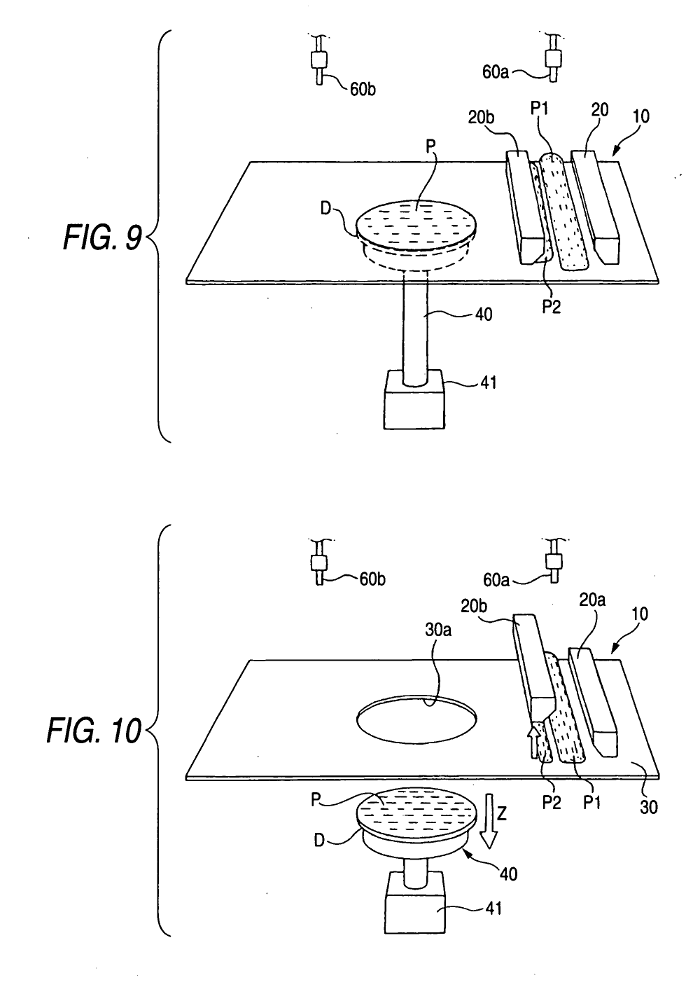

As for FIG. 9:

FIG. 9 shows a state in which the blade 20b has reached the final goal after the whole surface of the disk D is coated with the coating liquid P. On this occasion, the residual coating liquid P2 remains behind the front end of the blade 20b.

On the other hand, the blade 20a is moved down from the retraction position to an upstream side of the newly discharged/supplied coating liquid P1.

As for FIG. 10:

In FIG. 10, the blade 20b having reached the final goal completes its role and retracts upwards. At the same time, the disk D coated with the coating liquid P is moved down in the Z direction by the motor 41 while placed on the support member 40 so that the disk D can be exchanged for a new one D.

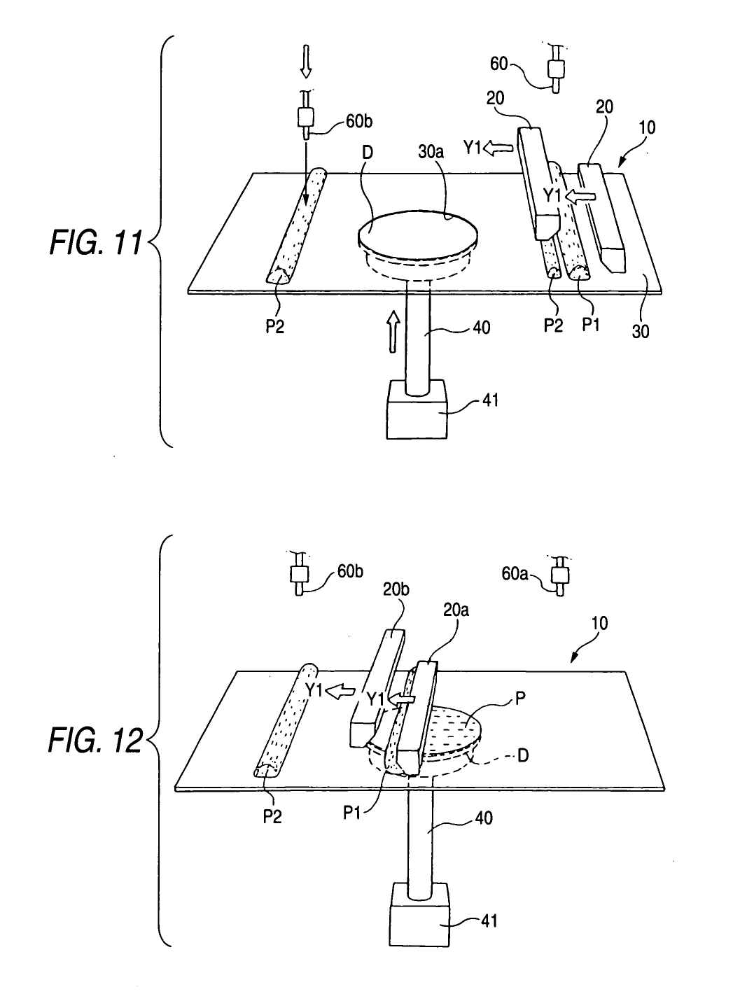

As for FIG. 11:

In FIG. 11, the new disk D to be coated next is then placed on the support member 40 so that a to-be-coated portion of the new disk D faces the opening 30a of the disk 30.

The blade 20b starts to move in the Y1 direction while kept in the retraction state (rise state). The blade 20a also starts to move in order to move the residual coating liquid P2 and the newly discharged coating liquid P1 in the Y1 direction.

On this occasion, the nozzle 60b is moved down to the discharge/supply position so that a coating liquid P2 is discharged from the nozzle 60b and supplied onto the mask 30.

As for FIG. 12:

FIG. 12 shows a state in which the blade 20a has moved approximately to the center of the opening in the Y1 direction so that the coating liquid P has been applied on a half part of the new disk D. In the meanwhile, the blade 20b is still moving in the Y1 direction while kept in the retraction state (rise state).

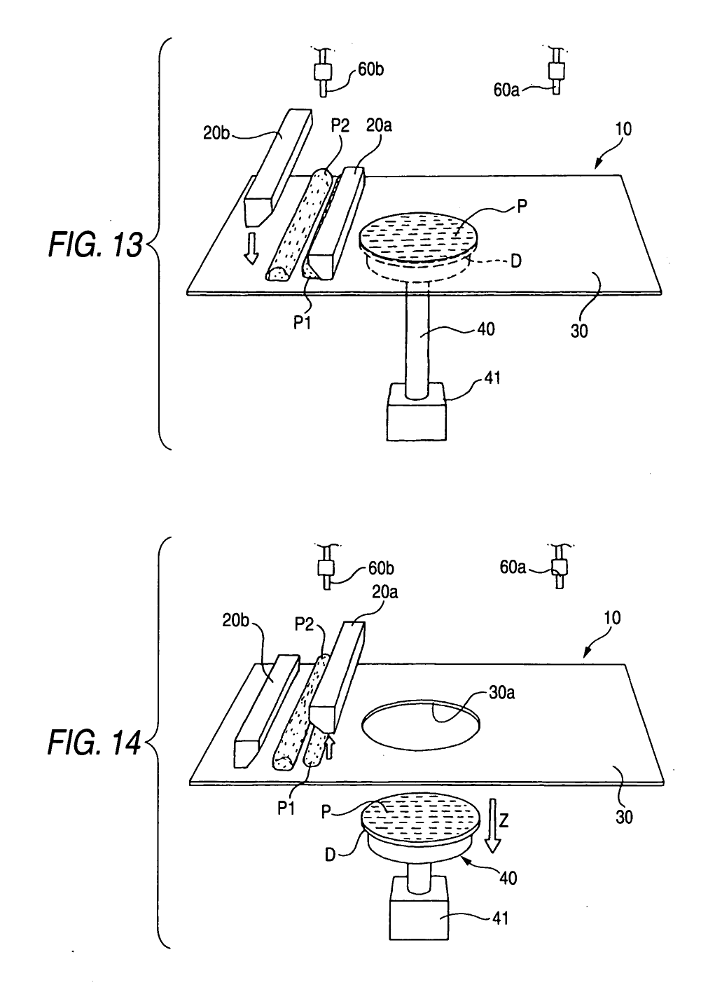

As for FIG. 13:

FIG. 13 shows a state in which the blade 20a has reached the final goal after the whole surface of the disk D is coated with the coating liquid P. On this occasion, the residual coating liquid P1 remains behind the front end of the blade 20a.

On the other hand, the blade 20b, which is located in the retraction position above a newly discharged/supplied coating solution P2 and on the upstream side of the coating solution P2, is moved down from the retraction position.

As for FIG. 14:

In FIG. 14, the blade 20a having reached the final goal completes its role and retracts upward. At the same time, the disk D coated with the coating liquid P is moved down in the Z direction by the motor 41 while placed on the support member 40.

FIG. 14 shows the same state as shown in FIG. 6.

When the blade 20a retracts upward, the coating liquid drops down from the lower end of the blade 20a. Therefore, a cover may be put on the blade 20a so that the blade 20a is ordinarily retracted to a position (e.g. upper position) where the blade 20a does not interfere with a coating operation, and that the cover is moved down so as to be disposed below the blade 20a when the blade 20a retracts upward.

Then, the situation of this routine goes from FIG. 6 to FIG. 7 which shows a steady state. After the situation of this routine reaches FIG. 14, the situation of this routine goes back to FIG. 6. This operation is repeated to apply the coating liquid on disks.

As described above, in this background-art apparatus, there is a possibility that scratches will be generated partially on the disk surface because a sufficiently small amount of coating liquid is supplied so that there is no remaining coating liquid P3. On the other hand, in the invention, there is no possibility that scratches will be generated partially on the disk surface because a sufficiently large amount of coating liquid is supplied so that there is a remaining coating liquid P3. Furthermore, in the invention, the remaining coating liquid can be reused because the remaining coating liquid is always moved back and forth by the two blades. In addition, in the invention, there is no chance for the remaining coating liquid to be solidified because the remaining coating liquid is returned without interposition of any path (for collecting the remaining coating liquid in a collection tank to dry the remaining coating liquid easily) immediately after the remaining coating liquid reaches the goal and because a new coating liquid is added sometimes.

### Embodiment 2

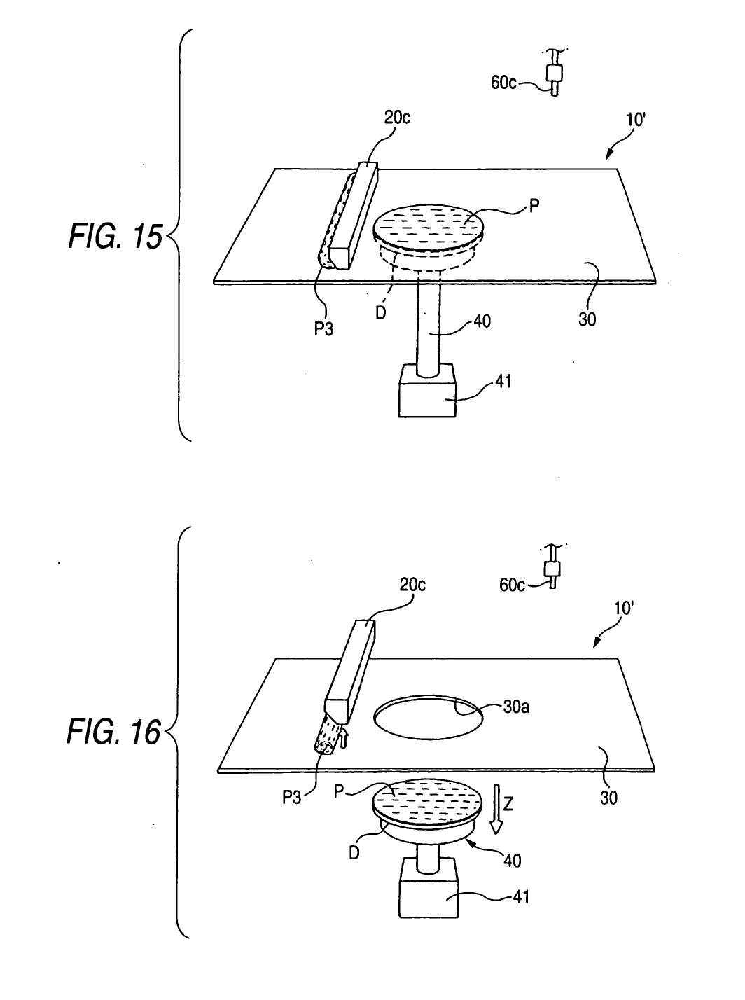

FIGS. 15 to 19 show a blade coating apparatus according to Embodiment 2 of the invention.

Embodiment 2 is common to Embodiment 1 in that the residual coating liquid is always moved back and forth so that the residual coating liquid can be used effectively without solidification. Embodiment 2 is different from Embodiment 1 in that the reciprocating motion of the remaining coating liquid is driven by only one blade in Embodiment 2.

As for FIG. 15:

FIG. 15 shows a state in which a blade 20c has reached a final goal after the whole surface of a disk D is coated with a coating liquid P. On this occasion, a sufficient quantity of a residual coating liquid P3 remains behind a front end of the blade 20c.

As for FIG. 16:

In FIG. 16, the blade 20c having reached the final goal completes its role and is moved up. At the same time, the disk D coated with the coating liquid P is moved down in a Z direction by a motor 41 while placed on a support member 40.

As for FIG. 17:

In FIG. 17, the blade 20c having been moved up is then rotated by 180° in a horizontal plane. The disk D coated with the coating liquid P is removed from the support member 40. A new disk D to be coated next is then placed on the support member 40.

As for FIG. 18:

In FIG. 18, the blade 20c having been rotated by 180° in the horizontal plane is moved down and landed on a mask 30.

The new disk D is placed on the support member 40 and fixed by vacuum suction. In this condition, the new disk D is moved up in the Z direction by the motor 41.

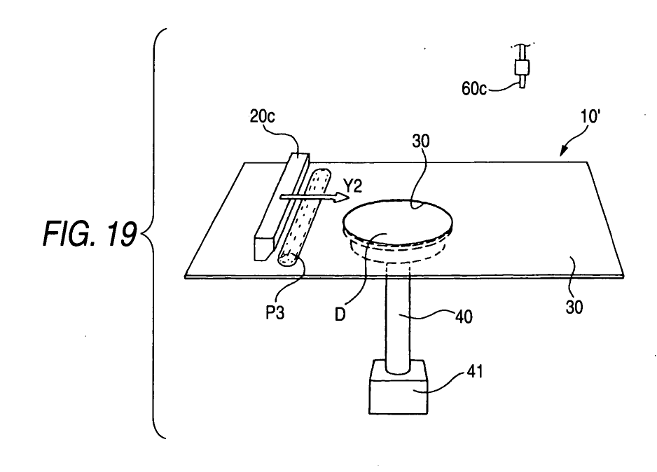

As for FIG. 19:

In FIG. 19, the blade 20c having been landed on the mask 30 starts to move in a Y2 direction this time. A residual coating liquid P3 remains just in front of the blade 20c. In the case of Embodiment 2, a large value is selected as the aforementioned value in the range of from 2Q to 5Q. Accordingly, a quantity of the residual coating liquid P3 corresponding to the quantity of the residual coating liquids P1+P2 in Embodiment 1 still remains. Accordingly, the number of required nozzles is only one 60c.

According to Embodiment 2, a large amount of coating liquid is supplied initially so that a sufficiently large amount of coating liquid P3 remains. Accordingly, the number of required nozzles is only one 60c. The residual coating liquid P3 can be always moved back and forth by only one blade 20c. Accordingly, the coating liquid P3 can be used efficiently and fully because the coating liquid P3 is neither dried nor solidified.

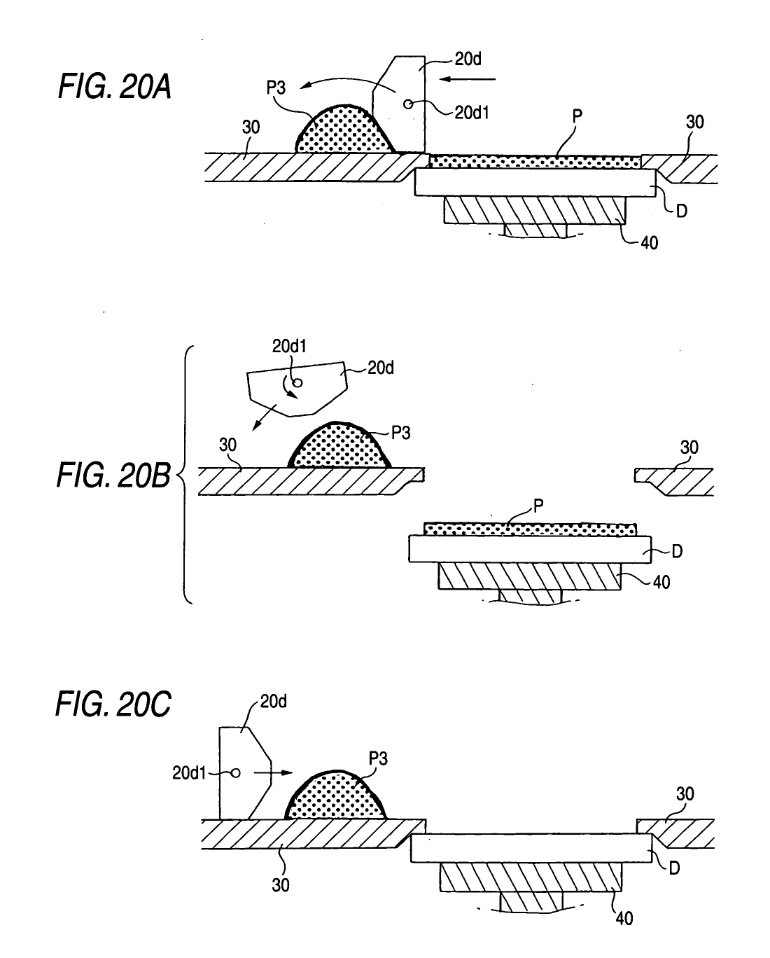

FIGS. 20A to 20C show a modification of Embodiment 2.

In Embodiment 2, one blade is moved back and forth. Although description has been made on the case where the blade is rotated by 180° in the horizontal plane, this modification shows the case where the blade is rotated on its own axis taken along the lengthwise direction of the blade.

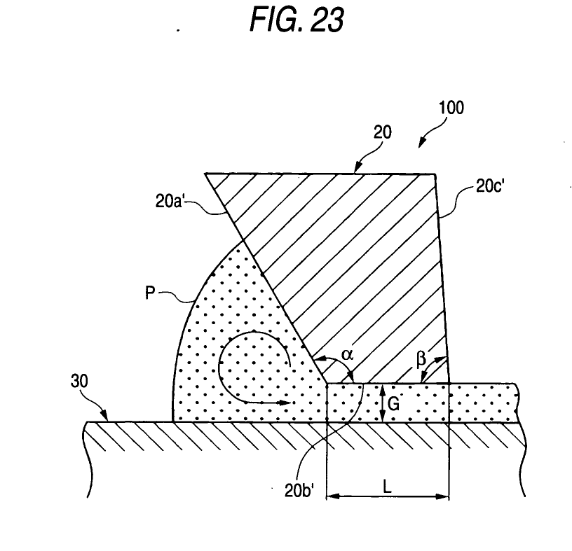

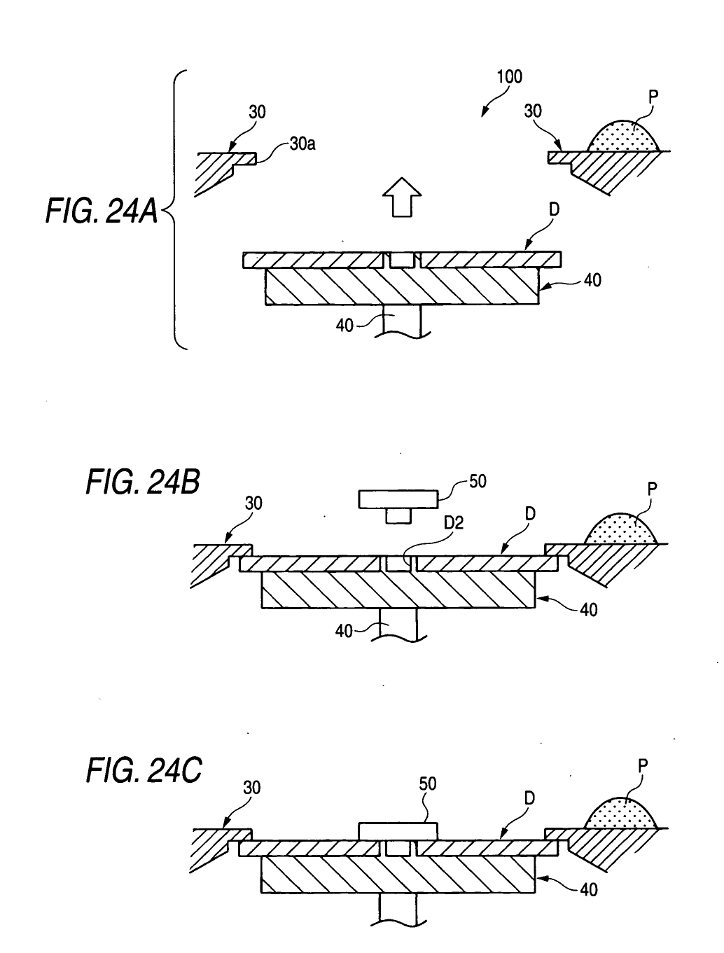

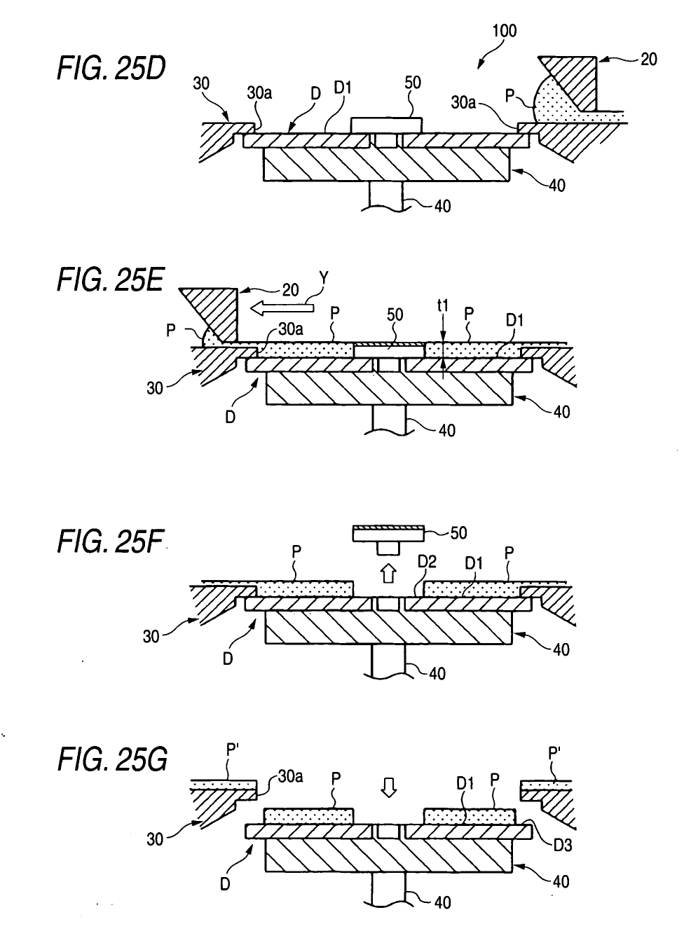

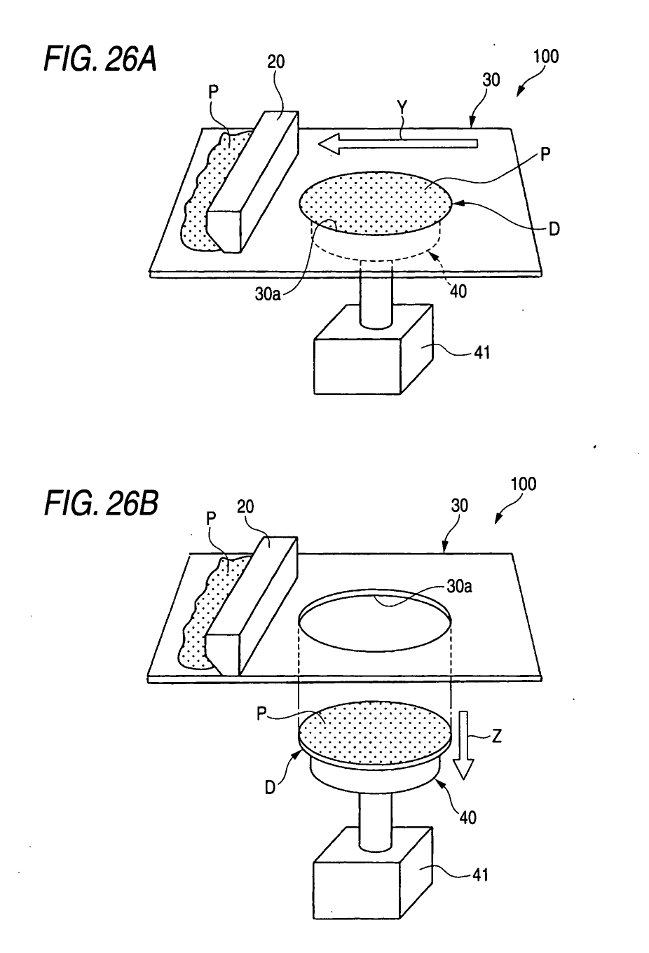

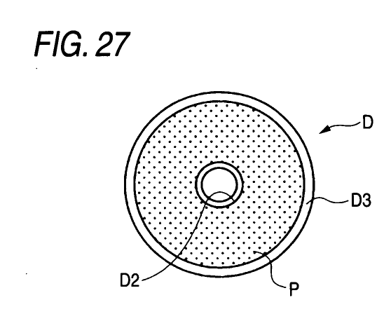

A section of the blade 20d used here is shaped like a section of two rectangular blades, that is, shaped as if the rectangular blade 20 shown in FIG. 23 is projected upward with its upper side (in FIG. 23) as a symmetry axis.

FIG. 20A shows a state in which the blade 20d has reached a final goal after the whole surface of a disk D is coated with a coating liquid P. On this occasion, a sufficient quantity of the residual coating liquid P3 remains behind a front end of the blade 20d.

In FIG. 20B, the blade 20d having reached the final goal is moved up so as to pass over the residual coating liquid P3 and starts to rotate by 180° on its own axis 20d1.

On the other hand, the disk D coated with the coating liquid P is moved down while placed on the support member 40 in order to exchange the disk D for a new one D.

In FIG. 20C, the blade 20d having rotated by 180° on its own axis 20d1 is landed on the mask 30 and on a left side (downstream side in the preceding movement direction) of the residual coating liquid P3 and starts to apply the coating liquid in a reverse direction. On this occasion, the new disk D has been already moved up in the condition that the new disk D is placed on the support member 40 and fixed by vacuum suction.

Because the coating surface of the blade 20d used at the preceding stroke has been already rotated by 180° on its own axis 20d1 and has been already located in an upper position, the coating liquid stuck at the preceding stroke is dropped down through the blade 20d so that the coating liquid can be reused at the current coating stroke. Thus, the coating liquid can be used effectively.

According to the modification of Embodiment 2, a quantity of the residual coating liquid P3 corresponding to the quantity of the residual coating liquids P1+P2 in Embodiment 1 still remains. Accordingly, the number of required nozzles is only one. Because the residual coating liquid P3 can be always moved back and forth by only one blade 20d, the coating liquid P3 is neither dried nor solidified so that the coating liquid can be used effectively and fully.

### Embodiment 3

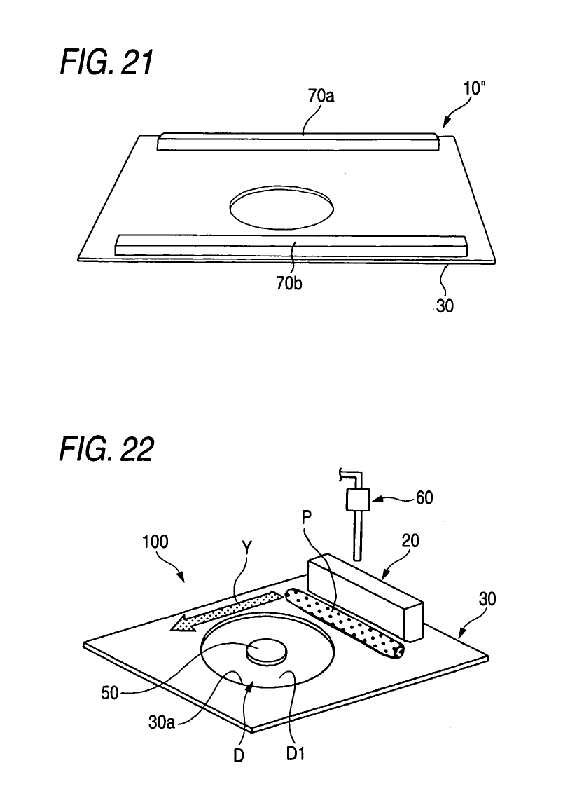

FIG. 21 shows a blade coating apparatus according to Embodiment 3 of the invention.

The reference numeral 10″ designates a blade coating apparatus according to Embodiment 3 of the invention. Constituent parts provided in FIG. 1 (Embodiment 1) or FIG. 15 (Embodiment 2) are also used in Embodiment 3. In order to describe Embodiment 3 in an easily understandable way, illustration will be omitted here.

In the blade coating apparatus according to the invention, there is a possibility that the coating liquid will be spread in the lengthwise direction of the blade and dropped down from ends of the mask 30 (rear and front sides of the mask 30 in FIG. 21) when time passes while the reciprocating motion of the blade is repeated any number of times because a large amount of the coating liquid is used in the invention.

Embodiment 3 aims at avoiding this possibility. As is obvious from FIG. 21, coating liquid leakage preventing dams 70a and 70b are laid on the mask 30 (on the front and rear ends of the mask 30 in FIG. 21) to be far by a predetermined distance from opposite ends of a blade respectively in a lengthwise direction of the blade and in parallel to the direction of movement of the blade.

In this manner, the coating liquid can be prevented from being spread in the lengthwise direction of the blade and dropped down from the ends of the mask.

Such printing that the aperture ratio of the mask to a subject of coating, especially to a printable surface of a printable optical disk is approximately 100% is required. Accordingly, when the coating method according to the invention is performed, it is possible to avoid waste of the coating liquid and it is possible to obtain a perfect coating layer without occurrence of scratches in the coating layer.

Generally, in the case of screen printing, coating irregularity etc. is not conceivable because the aperture ratio of the mask to a to-be-coated surface of a subject of coating is small, and the aperture ratio of the mask does not decrease in accordance with a predetermined relation as the location goes from a central portion of the blade to end portions of the blade in a lengthwise direction of the blade. On the other hand, when a disk as a subject of coating is coated according to the invention, there is a possibility that scratches will be generated in a portion passing through the center of the blade as a result of remarkable consumption of the coating liquid in this portion because printing is performed by blade coating using such a mask 30 that the aperture ratio of the mask 30 to the whole area of the disk D is approximately 100%.

Accordingly, when a sufficient large quantity of the coating liquid two times to five times as much as the quantity of the coating liquid consumed at one stroke is supplied, scratches can be prevented. On the other hand, the present inventor has faced another new problem caused consequently by the sufficient large quantity of the coating liquid, that is, a problem about handling of a large quantity of a residual coating liquid generated at each stroke.

In the invention, the residual coating liquid carried by the first blade is successively moved in a reverse direction by another blade on the opposite side or by the first blade making a reciprocating or rotating motion. When this operation is repeated, the coating liquid once supplied onto the mask is applied finally fully. Accordingly, the coating liquid can be used effectively without waste.

This application is based on Japanese Patent application JP 2005-43948, filed Feb. 21, 2005, the entire content of which is hereby incorporated by reference, the same as if set forth at length.

What is claimed is:

1. A blade coating method using a plurality of blades for applying coating liquid on surfaces of disk-like flat substrates to thereby form coating layers on to-be-coated surfaces of the flat substrates respectively, the method comprising:
attaching a mask onto a flat substrate, the mask having an aperture large enough to apply the coating liquid on the whole surface of the flat substrate except a circumferential edge portion of the flat substrate; and
moving each blade from an upstream side to a downstream side relative to the mask with a predetermined gap formed between the blade and the flat substrate, thereby extruding the coating liquid onto the mask through the gap formed on the downstream side of the blade while moving the coating liquid supplied on the upstream side of the blade by the blade to thereby form the coating layer on the surface of the flat substrate;
wherein after a first one of the blades applies the coating liquid on a surface of a disk-like flat substrate in a direction, the first blade retracts and a second one of the blades applies the coating liquid on a surface of a next disk-like flat substrate in a direction reverse to the direction applied by the first blade.

2. A blade coating method using a blade for applying coating liquid on surfaces of disk-like flat substrates to form coating layers on to-be-coated surfaces of the flat substrates respectively, the method comprising:
attaching a mask onto a flat substrate, the mask having an aperture large enough to apply the coating liquid on the whole surface of the flat substrate except a circumferential edge portion of the flat substrate; and
moving the blade from an upstream side to a downstream side relative to the mask with a predetermined gap formed between the blade and the flat substrate, thereby extruding the coating liquid onto the mask through the gap formed on the downstream side of the blade while moving the coating liquid supplied on the upstream side of the blade by the blade to thereby form the coating layer on the surface of the flat substrate;
wherein after the blade applies the coating liquid on a surface of a disk-like flat substrate in a direction, the blade moves to an opposite side with respect to a residual part of the coating liquid and subsequently applies the coating liquid on a surface of a next disk-like flat substrate in a reverse direction to the direction.

3. An optical disk having at least one layer of a printable surface formed by the blade coating method as claimed in claim 1.

4. An optical disk having at least one layer of a printable surface formed by the blade coating method as claimed in claim 2.

5. A blade coating apparatus comprising:
a subject attachment for attaching a disk-like flat substrate as a subject on which coating liquid is to be applied;
a first blade for moving from an upstream side to a downstream side above the subject attachment and relative to the subject attachment with a predetermined gap formed between the first blade and the subject attachment;
a second blade for moving from the downstream side to the upstream side above the subject attachment and relative to the subject attachment with a predetermined gap formed between the second blade and the subject attachment; and
a nozzle for supplying the coating liquid to at least one side of the first and second blades;
wherein after the first blade applies the coating liquid on a surface of a disk-like flat substrate in a direction, the first blade retracts and the second blade applies the coating liquid to a surface of a next disk-like flat substrate in a direction reverse to the direction applied by the first blade.

6. A blade coating apparatus comprising:
a subject attachment for attaching a disk-like flat substrate as a subject on which coating liquid is to be applied;
a first blade for moving from an upstream side to a downstream side above the subject attachment and relative to the subject attachment with a predetermined gap formed between the first blade and the subject attachment;
a second blade for moving from the downstream side to the upstream side above the subject attachment and relative to the subject attachment with a predetermined gap formed between the second blade and the subject attachment;
a first nozzle for supplying the coating liquid to the first blade side; and
a second nozzle for supplying a coating liquid to the second blade side;
wherein:
the first blade applies the coating liquid from the upstream side to the downstream side after the first nozzle supplies the coating liquid; and
the second blade applies the coating liquid from the downstream side to the upstream side after the second nozzle supplies the coating liquid.

7. The blade coating apparatus according to claim 6, wherein:
the first nozzle supplies the coating liquid when the first blade is on the downstream side of the subject attachment; and
the second nozzle supplies the coating liquid when the second blade is on the upstream side of the subject attachment.

8. A blade coating apparatus comprising:
a subject attachment for attaching a disk-like flat substrate as a subject on which coating liquid is to be applied;
a blade for moving from an upstream side to a downstream side above the subject attachment and relative to the subject attachment with a predetermined gap formed between the blade and the subject attachment; and
a nozzle for supplying the coating liquid onto a front end of the blade in a direction of movement of the blade;
wherein after the blade applies the coating liquid on a surface of a disk-like flat substrate in a direction, the blade moves to an opposite end with respect to a residual part of the coating liquid and subsequently applies the coating liquid on a surface of a next disk-like flat substrate in a reverse direction to the direction.

9. The blade coating apparatus according to claim 8, wherein after the blade applies the coating liquid on a surface of a disk-like flat substrate in a direction, the blade is moved above the residual part of the coating liquid, rotated around the residual part of the coating liquid by 180° in a horizontal plane, moved down to the opposite end with respect to the residual part of the coating liquid, and subsequently applies the coating liquid on a surface of a next disk-like flat substrate in a reverse direction to the direction.

10. The blade coating apparatus according to claim 5, wherein each nozzle supplements coating liquid once each stroke or once each predetermined number of strokes so that the blade can always move a quantity of the coating liquid equal to two times to five times as much as the quantity of the coating liquid to be applied on the flat substrate with one stroke of the blade.

11. The blade coating apparatus according to claim 6, wherein each nozzle supplements coating liquid once each stroke or once each predetermined number of strokes so that the blade can always move a quantity of the coating liquid equal to two times to five times as much as the quantity of the coating liquid to be applied on the flat substrate with one stroke of the blade.

12. The blade coating apparatus according to claim 8, wherein each nozzle supplements coating liquid once each stroke or once each predetermined number of strokes so that the blade can always move a quantity of the coating liquid equal to two times to five times as much as the quantity of the coating liquid to be applied on the flat substrate with one stroke of the blade.

13. The blade coating apparatus according to claim 5, further comprising coating liquid leakage preventing dams which are laid at a predetermined distance from opposite ends of the blade respectively and in parallel to the direction of movement of the blade.

14. The blade coating apparatus according to claim 6, further comprising coating liquid leakage preventing dams which are laid at a predetermined distance from opposite ends of the blade respectively and in parallel to the direction of movement of the blade.

15. The blade coating apparatus according to claim 8, further comprising coating liquid leakage preventing dams which are laid at a predetermined distance from opposite ends of the blade respectively and in parallel to the direction of movement of the blade.
